(19) United States
(12) Patent Application Publication
(10) Pub. No.: US 2024/0253430 A1
(43) Pub. Date: Aug. 1, 2024

(54) BOARD-TYPE SUNSHADE AND SUNSHADE APPARATUS FOR MOTOR VEHICLES PROVIDED WITH BOARD-TYPE SUNSHADE

(71) Applicant: HOWA CO., LTD., Kasugai-shi, Aichi (JP)

(72) Inventors: Shinobu FUSHIKI, Kasugai-shi (JP); Takumi TSUBOI, Kasugai-shi (JP)

(73) Assignee: HOWA CO., LTD., Kasugai-shi, Aichi (JP)

(21) Appl. No.: 17/781,426

(22) PCT Filed: Dec. 3, 2021
(86) PCT No.: PCT/JP2021/044485

§ 371 Date: Apr. 16, 2024

(30) Foreign Application Priority Data
Apr. 16, 2021 (JP) 2021-069742

(51) Int. Cl. B60J 3/02; B29C 43/20; B29C 70/08; B29C 70/18; B29C 70/42; B60J 7/043

(52) U.S. Cl. CPC B60J 3/0278; B29C 43/203; B29C 70/086; B29C 70/18; B29C 70/42; B60J 7/043

(57) ABSTRACT

A sunshade is formed by laminating a front skin member, a core member, and a back skin member in this order, and the core member is formed by laminating a resin-impregnated semi-hard urethane foam layer between two glass fiber mats.

### BACKGROUND OF THE INVENTION

### Field of the Invention

The present invention relates to a board-type sunshade and a sunshade apparatus for motor vehicles provided with the board-type sunshade.

### Description of the Related Art

In general, a board-type sunshade is desirably lightweight in terms of handling. For example, when the board sunshade is mounted on a motor vehicle as a sunshade apparatus, the board-type sunshade is required in recent years to be lightweight from the viewpoint of improving fuel efficiency of the motor vehicle. Furthermore, the sunshade is required to be a strong sunshade having rigidity that is not easily deformed in order to favorably keep the shape as a board type.

In view of these requirements, conventionally, as this type of board-type sunshade, a sunshade for a sunroof of a motor vehicle described in JP 3592274 B2 has been disclosed.

The sunshade adopts a semi-hard urethane foam layer and two resin-impregnated glass fiber mats as materials for forming a core member in order to ensure rigidity capable of keeping a shape as a board type, in addition to lightweight. Under such adoption, the core member of the sunshade is formed by laminating the semi-hard urethane foam layer between the two resin-impregnated glass fiber mats.

In the core member, each of the two resin-impregnated glass fiber mats is formed by impregnating a glass fiber mat with a liquid thermosetting resin and curing the liquid thermosetting resin. As a result, the use of the two resin-impregnated glass fiber mats becomes a factor that causes an increase in weight as a sunshade, but attempts to respond to a demand for higher rigidity of the sunshade.

On the other hand, since the semi-hard urethane foam layer is lightweight, further increase in weight as a core member can be suppressed. In addition, since the semi-hard urethane foam layer has flexibility suitable for the material of the core member of the sunshade, the semi-hard urethane foam layer forms the core member together with the two resin-impregnated glass fiber mats.

Thus, a front skin layer formed of front skin material is laminated on one resin-impregnated glass fiber mat of the two resin-impregnated glass fiber mats of the core member from the front surface side, and a back skin layer formed of back skin material is laminated on the other resin-impregnated glass fiber mat of the two resin-impregnated glass fiber mats from the back surface side.

As described above, the front skin layer, the one resin-impregnated glass fiber mat, the semi-hard urethane foam layer, the other resin-impregnated glass fiber mat, and the back skin layer are laminated to form a multilayer laminate. The multilayer laminate formed in this manner is formed as a sunshade by being subjected to compression molding using a press die while being heated and pressed.

In the sunshade configured as described above, each of the two resin-impregnated glass fiber mats is formed by impregnating the glass fiber mat with the liquid thermosetting resin and curing the liquid thermosetting resin as described above.

In the impregnation described above, in order to further enhance the rigidity as the resin-impregnated glass fiber mat, it is desirable to increase the basis weight of the liquid thermosetting resin impregnated into the glass fiber mat.

However, although the rigidity of the sunshade can be mainly ensured by the two resin-impregnated glass fiber mats, the two glass fiber mats in the two resin-impregnated glass fiber mats results in an increase in weight as described above. Therefore, from the viewpoint of weight reduction, the basis weight of each of the two glass fiber mats is desirably as small as possible.

For this reason, the basis weight of the liquid thermosetting resin impregnated into the glass fiber mat is inevitably limited. This is the reason for failing to meet the recent demand for further improvement in rigidity and strength of the sunshade as a board type.

### SUMMARY OF INVENTION

It is therefore an object of the present invention to provide a board-type sunshade in which by focusing on the characteristics of semi-hard urethane foam, at least a semi-hard urethane foam layer of semi-hard urethane foam is impregnated with a liquid thermosetting resin and the liquid thermosetting resin is cured to further increase rigidity.

It is another object of the present invention to provide a sunshade apparatus for motor vehicles provided with the board-type sunshade.

In solving the above-mentioned problems, a board-type sunshade according to the present invention includes a front skin member, a back skin member, and a core member laminated between the front skin member and the back skin member.

In the board-type sunshade, the core member includes two glass fiber mats and a resin-impregnated semi-hard urethane foam layer laminated between the two glass fiber mats. The resin-impregnated semi-hard urethane foam layer is formed by impregnating a semi-hard urethane foam layer over its entirety with a liquid thermosetting resin and curing the liquid thermosetting resin.

According to the above configuration, as described above, the core member includes the two glass fiber mats and the resin-impregnated semi-hard urethane foam layer laminated between the two glass fiber mats. Here, the resin-impregnated semi-hard urethane foam layer is formed by impregnating the semi-hard urethane foam layer over its entirety with the liquid thermosetting resin and curing the liquid thermosetting resin.

Further, in the core member, although the two glass fiber mats are higher in rigidity than the semi-hard urethane foam layer due to the structure thereof, each of the two glass fiber mats is heavier than the semi-hard urethane foam layer of semi-hard urethane foam since the two glass fiber mats each is formed of glass fibers.

Therefore, from the viewpoint of the weight reduction of the sunshade, it is a matter of course that the increase in the basis weight of each of the two glass fiber mats is limited. Accordingly, an increase in the basis weight of the liquid thermosetting resin impregnated into the two glass fiber mats is also limited. This means that when the liquid thermosetting resin is impregnated into the two glass fiber mats and is cured to form the two resin-impregnated glass fiber mats, the rigidity of the board-type sunshade is not further improved.

On the other hand, the semi-hard urethane foam which is the material for forming the semi-hard urethane foam layer is lightweight. Therefore, even from the viewpoint of the weight reduction of the sunshade, the basis weight of the semi-hard urethane foam layer can be increased. This means that, in formation of the resin-impregnated semi-hard urethane foam layer, the basis weight of the thermosetting resin impregnated into the semi-hard urethane foam layer can be significantly increased as compared with the sum of the basis weights of the thermosetting resin that can be impregnated into the two glass fiber mats.

According to the present invention, therefore, the core member is formed by laminating the resin-impregnated semi-hard urethane foam layer between the two glass fiber mats. With this configuration, the rigidity of the core member, and thus the rigidity of the board-type sunshade, can be greatly improved. As a result, the board-type sunshade is capable of keeping the original board shape favorably without being deformed even when receiving an external force.

Further, in the present invention, the front skin member includes a front skin layer and a front skin layer-side adhesive layer, and the back skin member includes a back skin layer and a back skin layer-side adhesive layer.

In the core member, one glass fiber mat of the two glass fiber mats is bonded to the front skin layer with the front skin layer-side adhesive layer so as to face the front skin layer through the front skin layer-side adhesive layer, and the other glass fiber mat is bonded to the back skin layer with the back skin layer-side adhesive layer so as to face the back skin layer through the back skin layer-side adhesive layer.

As described above, by specifying the configurations of the front skin member and the back skin member and specifying the laminated configuration between the front skin member and the back skin member of the core member, the above-described operation and effect of the present invention can be more specifically achieved.

Further, according to the present invention, in the resin-impregnated semi-hard urethane foam layer, the liquid thermosetting resin impregnated into the semi-hard urethane foam layer has a basis weight within a predetermined basis weight range.

By specifying the basis weight of the liquid thermosetting resin as described above, the rigidity of the core member, in other words, the rigidity of the board-type sunshade can be more specifically ensured. As a result, the above-described operation and effect of the present invention can be more specifically achieved.

Further, in the present invention, the predetermined basis weight range of the basis weight of the liquid thermosetting resin impregnated into the semi-hard urethane foam layer is 150 g/m² to 500 g/m².

According to this configuration, the above-described operation and effect of the present invention can be more specifically achieved.

Further, in the present invention, the basis weight of the liquid thermosetting resin may be more preferably a value within 200 g/m²±20 g/m².

Further, according to the present invention, in the board-type sunshade described above,
the core member includes two resin-impregnated glass fiber mats,
the two resin-impregnated glass fiber mats are formed respectively by impregnating a corresponding one of the two glass fiber mats over its entirety with a liquid thermosetting resin and curing the liquid thermosetting resin, and
the resin-impregnated semi-hard urethane foam layer is laminated between the two resin-impregnated glass fiber mats.

According to this configuration, the core member includes the two resin impregnated glass fiber mats, in addition to the resin-impregnated semi-hard urethane foam layer. In other words, the core member is formed to have rigidity obtained by adding the rigidity of each of the two resin-impregnated glass fiber mats in addition to the rigidity of the resin-impregnated semi-hard urethane foam layer.

Therefore, the rigidity as the board-type sunshade described above can be further improved. As a result, the board-type sunshade is capable of keeping a board shape that is further reinforced.

According to the present invention configured as described above, in the core member, one resin-impregnated glass fiber mat of the two resin-impregnated glass fiber mats may be bonded to the front skin layer with the front skin layer-side adhesive layer so as to face the front skin layer through the front skin layer-side adhesive layer, and the other resin-impregnated glass fiber mat may be bonded to the back skin layer with the back skin layer-side adhesive layer so as to face the back skin layer through the back skin layer-side adhesive layer.

As described above, even when the core member has a structure in which the resin-impregnated semi-hard urethane foam layer is laminated between the two resin-impregnated glass fiber mats, the operation and effect of the present invention can be more specifically achieved by specifying the configurations of the front skin member and the back skin member and specifying the laminated configuration between the front skin member and the back skin member of the core member as described above.

Further, according to the present invention, in the two resin-impregnated glass fiber mats, each of the glass fiber mats may have a basis weight within a first predetermined basis weight range, and the liquid thermosetting resin impregnated into each of the glass fiber mats may have a basis weight within a second predetermined basis weight range. In the resin-impregnated semi-hard urethane foam layer, the liquid thermosetting resin impregnated into the semi-hard urethane foam layer may have a basis weight within a third predetermined basis weight range.

As described above, by specifying the basis weights of the resin-impregnated semi-hard urethane foam layer, each of the two resin-impregnated glass fiber mats, and the liquid thermosetting resin of the core member, the rigidity of the core member, in other words, the rigidity of the board-type sunshade can be more specifically ensured. As a result, the operation and effect of the present invention can be more specifically achieved.

Here, in the present invention, the first predetermined basis weight range of the basis weight of each of the two glass fiber mats may be 100 g/m² to 500 g/m², the second predetermined basis weight range of the basis weight of the liquid thermosetting resin impregnated into each of the glass fiber mats may be 20 g/m² to 50 g/m², and the third predetermined basis weight range of the basis weight of the liquid thermosetting resin impregnated into the semi-hard urethane foam layer may be 150 g/m² to 500 g/m².

By specifying the basis weight range of the basis weight of each of the two glass fiber mats, and also specifying the basis weight range of the basis weight of the liquid thermosetting resin impregnated into each of the glass fiber mats and the semi-hard urethane foam layer in this manner, the above-described operation and effect of the present invention can be more specifically achieved.

Further, in the present invention, the basis weight of the liquid thermosetting resin impregnated into each of the glass fiber mats may more preferably have a value within 30 g/m²±3 g/m², and the basis weight of the liquid thermosetting resin impregnated into the semi-hard urethane foam layer may more preferably have a value within 200 g/m²±20 g/m².

In addition, in the present invention, the liquid thermosetting resin may be a liquid isocyanate.

Further, a board-type sunshade apparatus for a motor vehicle according to the present invention is applied through two guide rails to a window formed in a sunroof of the motor vehicle, for opening and closing the window.

The board-type sunshade apparatus includes a board-type sunshade and a plurality of sliding members. The board-type sunshade includes a front skin member, a back skin member, and a core member laminated between the front skin member and the back skin member.

The core member includes two glass fiber mats and a resin-impregnated semi-hard urethane foam layer laminated between the two glass fiber mats.

The resin-impregnated semi-hard urethane foam layer is formed by impregnating a semi-hard urethane foam layer over its entirety with a liquid thermosetting resin and curing the liquid thermosetting resin.

The plurality of sliding members are respectively attached to at least rear portions of left and right edges of the board-type sunshade.

According to this configuration, the board-type sunshade includes the core member formed by laminating the resin-impregnated semi-hard urethane foam layer between the two glass fiber mats. Therefore, on the premise that the above board-type sunshade is capable of achieving the above-described operation and effect of the board-type sunshade according to the present invention, it is possible to provide the sunshade apparatus including the board-type sunshade.

Further, according to the present invention, in the board-type sunshade apparatus for the motor vehicle described above,
the core member includes two resin-impregnated glass fiber mats,
the two resin-impregnated glass fiber mats are formed respectively by impregnating a corresponding one of the two glass fiber mats over its entirety with a liquid thermosetting resin and curing the liquid thermosetting resin,
the resin-impregnated semi-hard urethane foam layer is laminated between the two resin-impregnated glass fiber mats, and
the plurality of sliding members are respectively attached to at least rear portions of left and right edges of the sunshade.

According to this configuration, the board-type sunshade includes the core member formed by laminating the resin-impregnated semi-hard urethane foam layer between the two resin-impregnated glass fiber mats. Therefore, on the premise that the above board-type sunshade is capable of achieving the above-described operation and effect of the board-type sunshade according to the present invention, it is capable to provide the sunshade apparatus including the board-type sunshade.

Further, in the sunshade apparatus for the motor vehicle according to the present invention,
the board-type sunshade includes a flat plate center, front and rear ends respectively extending forward and rearward from the flat plate center, and left and right edges respectively extending leftward and rightward from the flat plate center.

The left and right edges each include a front portion and a remaining portion excluding the front portion. The remaining portion is subjected to compression molding at a compression rate higher than a compression rate for the flat plate center, and the front portion is subjected to compression molding at a compression rate lower than the compression rate for the remaining portion.

The rear end is subjected to compression molding at a compression rate higher than the compression rate for the flat plate center, and the front end is compressed at a compression rate higher than the compression rate for the flat plate center and is formed to be curved toward the back skin member in a curved shape that is gently convex forward.

With this configuration, in the board-type sunshade which is a molding laminate formed by compression molding, the front end of the sunshade is formed to be curved toward the back skin member in a curved shape that is gently convex forward. Therefore, the core member is not exposed to the front skin member side, and the aesthetic appearance as the board-type sunshade can be favorably maintained.

As described above, since the compression rates for the remaining portions of the left and right edges other than the front portions and the compression rates for the front and rear portions are higher than the compression rate for the flat plate center, the corresponding portions of the core member to the remaining portions and the corresponding portions of the core member to the front and rear portions also have high rigidity. Accordingly, the outer peripheral portion of the board-type sunshade becomes hard. As a result, in opening and closing the sunshade apparatus, the board-type sunshade is capable of keeping the original board shape favorably without being deformed even when receiving an external force.

As described above, the front portions of the left and right edges are formed at the compression rate lower than the compression rates for the remaining portions of the left and right edges. Therefore, by using each front portion as a support portion in place of each front sliding member and assembling the sliding member to the rear portion of each of the left and right edges, when the sunshade apparatus is attached to a sunroof of the motor vehicle with the left and right guide rails, the board-type sunshade is capable of smoothly sliding each support portion along the inside of each of the left and right guide rails without adopting each front sliding member.

### BRIEF DESCRIPTION OF DRAWINGS

FIG. 1 is a schematic plan view of a motor vehicle, shown in a partially broken manner, to which a first embodiment of a sunshade apparatus according to the present invention is applied.

FIG. 2 is a schematic plan view showing the motor vehicle in FIG. 1 in a state in which a sunshade of the sunshade apparatus is open.

FIG. 3 is a schematic front surface view showing the sunshade apparatus in FIG. 1 in a state of being viewed from a front surface of the sunshade apparatus (a surface located on a vehicle compartment side of the motor vehicle).

FIG. 4 is a schematic back surface view showing the sunshade apparatus in FIG. 1 in a state of being viewed from a back surface of the sunshade apparatus (a surface located on a roof side of the motor vehicle).

FIG. 5 is an enlarged longitudinal sectional view of the sunshade apparatus taken along a line 5-5 in FIG. 3.

FIG. 6 is a schematic front surface view of the sunshade in FIG. 1 as viewed from its front surface.

FIG. 7 is a schematic back surface view of the sunshade in FIG. 1 as viewed from its back surface.

FIG. 8 is an enlarged longitudinal sectional view of the sunshade taken along a line 8-8 in FIG. 6.

FIG. 9 is an enlarged partial cross sectional view showing a portion (indicated by a circle A) of the sunshade in FIG. 8.

FIG. 10 is an enlarged exploded perspective view of the sunshade before a resin is impregnated into a core member of the first embodiment.

FIG. 11 is a table showing a maximum load and a bending elastic gradient with respect to a working sample and a comparative sample in the first embodiment.

FIG. 12 is a schematic configuration view showing a bending strength testing apparatus according to the first embodiment.

FIG. 13 is an enlarged longitudinal sectional view of a sunshade in a second embodiment of a sunshade apparatus according to the present invention.

FIG. 14 is an enlarged partial cross sectional view showing a portion (indicated by a circle B) of the sunshade in FIG. 13.

FIG. 15 is a schematic back surface view of a sunshade in a third embodiment of a sunshade apparatus according to the present invention as viewed from a back surface of the sunshade.

FIG. 16 is an enlarged longitudinal sectional view showing the sunshade in the third embodiment.

FIG. 17 is an enlarged partial side view showing the sunshade apparatus as viewed from a direction of an arrow C in FIG. 15.

FIG. 18 is a cross sectional view taken along a line 18-18 in FIG. 15.

FIG. 19 is a cross sectional view taken along a line 19-19 in FIG. 15.

FIG. 20 is a cross sectional view taken along a line 20-20 in FIG. 15.

### DETAILED DESCRIPTION OF THE PREFERRED EMBODIMENTS

Hereinafter, each embodiment of the present invention is described with reference to the drawings.

### First Embodiment

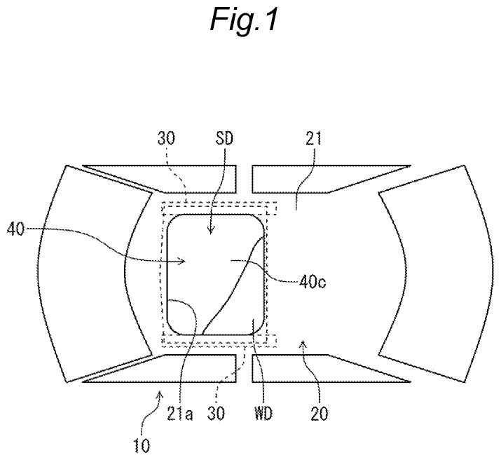

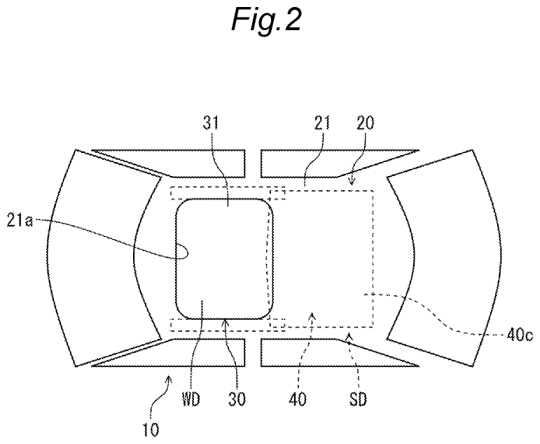

FIG. 1 shows a first embodiment of a sunshade apparatus in which the present invention is applied to a motor vehicle. The motor vehicle includes a vehicle body 10, Z and a window WD is provided on a roof 20 of the vehicle body 10. As shown in FIG. 1 or 2, the window WD is formed of a transparent panel fitted into an opening 21a (hereinafter, also referred to as an outer plate opening 21a) formed in an outer plate 21 of the roof 20. In the first embodiment, hereinafter, the sunshade apparatus is denoted by a reference sign SD.

In the first embodiment, the roof 20 having the window WD serves as a sunroof (hereinafter, also referred to as a sunroof 20) of the motor vehicle. The roof 20 includes the outer plate 21 and an inner plate (not shown) disposed inside the outer plate 21, and an opening (hereinafter, also referred to as an inner plate opening) is formed in a portion of the inner plate corresponding to the outer plate opening 21a. In FIGS. 1 and 2, the right side and the left side correspond to the front side and the rear side of the vehicle body 10, respectively.

The sunshade apparatus SD is applied to the sunroof 20 of the motor vehicle, and is slidably supported by the outer plate 21 in the front-rear direction with left and right guide rails 30 so as to face the window WD (see FIG. 1 or 2). The left and right guide rails 30 are each formed in a U-shaped cross section, and the left and right guide rails 30 are attached along the left and right portions of the outer plate opening 21a of the outer plate 21 from the inner plate side so as to face each other in the left-right direction at the longitudinal openings (see FIG. 1).

Thus, the sunshade apparatus SD is located at a position shown in FIG. 1 (hereinafter, also referred to as a shielding position) at the time of shielding the light incident through the window WD from the interior of the vehicle compartment. In addition, the sunshade apparatus SD slides along the left and right guide rails 30 to a position shown in FIG. 2 (hereinafter, also referred to as an incident position) at the time of causing light to be incident on the interior of the vehicle compartment through the window WD. Note that, at the incident position, the sunshade apparatus SD is located between the outer plate 21 and the inner plate of the roof 20.

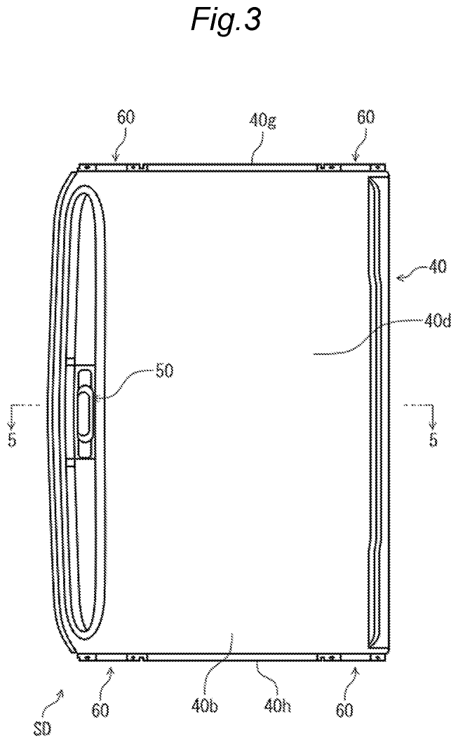

As shown in any of FIGS. 3 to 5, the sunshade apparatus SD includes a board-type sunshade 40, a knob 50, and four sliding members 60. As shown in any of FIGS. 3 to 9, the board-type sunshade 40 includes a core member 40a, a front skin member 40b, and a back skin member 40c. The back skin member 40c, the core member 40a, and the front skin member 40b are laminated in this order to form the sunshade 40 by press molding.

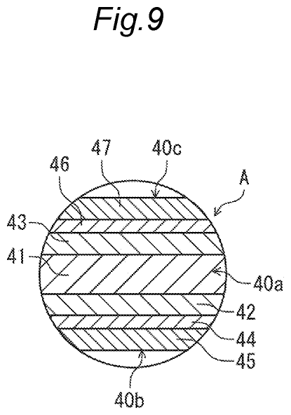

As shown in FIG. 9, the core member 40a includes a resin-impregnated semi-hard urethane foam layer 41 and two glass fiber mats 42 and 43. The resin-impregnated semi-hard urethane foam layer 41 is laminated between the two glass fiber mats 42 and 43. Hereinafter, in the first embodiment, among the two glass fiber mats 42 and 43, the glass fiber mat 42 is also referred to as a front skin layer-side glass fiber mat 42, and the glass fiber mat 43 is also referred to as a back skin layer-side glass fiber mat 43.

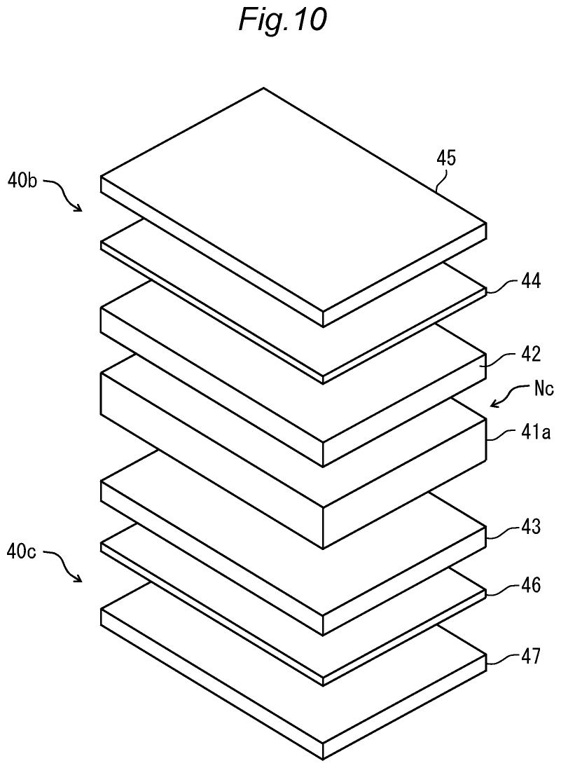

The resin-impregnated semi-hard urethane foam layer 41 is formed by impregnating a semi-hard urethane foam layer 41a (see FIG. 10) with a liquid thermosetting resin and curing the liquid thermosetting resin. In the first embodiment, FIG. 10 shows, in an exploded perspective view, a laminated structure (corresponding to a laminated structure of the board-type sunshade 40) in which a front skin layer 45, a barrier film 44, the front skin layer-side glass fiber mat 42, the semi-hard urethane foam layer 41a before resin impregnation, the back skin layer-side glass fiber mat 43, an adhesive film 46, and a back skin layer 47 are laminated.

In the laminated structure, the barrier film 44 and the front skin layer 45 constitute the front skin member 40b (described later), the front skin layer-side glass fiber mat 42, the semi-hard urethane foam layer 41a, and the back skin layer-side glass fiber mat 43 constitute a core member Nc before resin impregnation (corresponding to the core member 40a), and the adhesive film 46 and the back skin layer 47 constitute the back skin member 40c (described later).

The reason why the semi-hard urethane foam is adopted as described above in the resin-impregnated semi-hard urethane foam layer 41 is based on the following grounds.

The urethane foam is generally formed by foaming open cells and closed cells in urethane. The urethane foam becomes soft and exhibit good flexibility as the number of open cells becomes larger than the number of closed cells, and approaches a soft urethane foam. On the other hand, the urethane foam becomes hard and exhibits good hardness as the number of closed cells becomes larger than the number of open cells, and approaches a hard urethane foam.

Therefore, as the semi-hard urethane foam layer 41a for the board-type sunshade, it is desirable to employ a urethane foam (semi-hard urethane foam) obtained by forming open cells and closed cells in urethane so as to have hardness corresponding to rigidity capable of favorably keeping the shape as a board in the board-type sunshade.

The semi-hard urethane foam layer 41a formed of the above semi-hard urethane foam is excellent in air permeability because of many open cells formed therein, and favorably serves as a main component of the core member 40a of the board-type sunshade 40. Since the semi-hard urethane foam layer 41a is excellent in air permeability as described above, a liquid thermosetting resin is easily impregnated into the semi-hard urethane foam layer 41a.

The semi-hard urethane foam layer 41a is formed in a layered manner by using the semi-hard urethane foam having a basis weight within a predetermined basis weight range. The predetermined basis weight range refers to a range of 100 (g/m²) to 300 (g/m²). In the predetermined basis weight range, the lower limit value is set to 100 (g/m²) in order to prevent the semi-hard urethane foam layer 41a from becoming too soft and impairing semi-hardness suitable for the board-type sunshade. Meanwhile, the upper limit value is set to 300 (g/m²) in order to prevent the semi-hard urethane foam layer 41a from becoming too hard and impairing semi-hardness suitable for the board-type sunshade.

In addition, the resin to be impregnated into the semi-hard urethane foam layer 41a is a thermosetting resin, and the thermosetting resin is applied in a liquid form on the semi-hard urethane foam layer 41a over its entire surface from both surfaces, and is impregnated into the semi-hard urethane foam layer 41a and cured to be formed as a resin-impregnated semi-hard urethane foam layer 41.

As a result, the resin-impregnated semi-hard urethane foam layer 41 is formed to have such high rigidity that the original plate shape (board shape) can be favorably kept without being affected by the external force throughout the entire resin-impregnated semi-hard urethane foam layer 41 (see FIG. 9).

In the first embodiment, an example of the thermosetting resin includes an isocyanate. The amount of the isocyanate impregnated into the semi-hard urethane foam layer 41a is set to a value, in terms of a basis weight, within a predetermined basis weight range. Here, the predetermined basis weight range is set to such a range that the resin-impregnated semi-hard urethane foam layer 41 is capable of exhibiting high rigidity so as to keep the original plate shape (board shape) without being affected by the external force throughout the entire resin-impregnated semi-hard urethane foam layer 41.

In the first embodiment, the predetermined basis weight range of the basis weight of the isocyanate impregnated into the semi-hard urethane foam layer 41a is 100 (g/m²) to 500 (g/m²). The lower limit value is set to 100 (g/m²) in the predetermined basis weight range since the resin-impregnated semi-hard urethane foam layer 41 may fail to keep the original plate shape favorably due to insufficient rigidity when the basis weight is less than 100 (g/m²). The upper limit value is set to 500 (g/m²) since the liquid isocyanate oozes out from the surface of the semi-hard urethane foam layer 41a (resin-impregnated semi-hard urethane foam layer 41) after impregnation of the liquid isocyanate when the basis weight exceeds 500 (g/m²), which may impair the appearance of the resin-impregnated semi-hard urethane foam layer 41.

The two glass fiber mats 42 and 43 is formed respectively into a mat shape by entangling a large number of glass fibers. As a result, the two glass fiber mats 42 and 43 have respectively a structure capable of exhibiting good rigidity based on a structure in which a large number of rigid glass fibers are entangled.

Thus, among the two glass fiber mats 42 and 43, the front skin layer-side glass fiber mat 42 is laminated along the front surface (a front skin layer-side surface) of the resin-impregnated semi-hard urethane foam layer 41. Meanwhile, the back skin layer-side glass fiber mat 43 is laminated along the back surface (a back skin layer-side surface) of the resin-impregnated semi-hard urethane foam layer 41.

In this way, the two glass fiber mats 42 and 43 respectively on the front skin layer side and the back layer side play an auxiliary role of keeping the resin-impregnated semi-hard urethane foam layer 41 in the original plate shape (board shape) by sandwiching the resin-impregnated semi-hard urethane foam layer 41 under the rigidities thereof.

Here, the role of the core member 40a in the board-type sunshade is described. As the name suggests, the board-type sunshade refers to a board-shaped, that is, a plate-shaped sunshade. Considering that the board-type sunshade is configured as a device and is mounted on the sunroof 20 (the roof 20) of the motor vehicle, in opening and closing the window of the sunroof 20, the sunshade is required to easily move in the front-rear direction along the outer plate 21 of the sunroof 20, to have high rigidity so as not to be easily deformed, and to have a lightweight plate shape.

In order to meet the requirement, it is mandatory that in the board-type sunshade apparatus SD, the core member 40a which is a main member of the sunshade 40 have high rigidity. Therefore, in the first embodiment, the core member 40a is formed with the laminated structure of the resin-impregnated semi-hard urethane foam layer 41 and the two glass fiber mats 42 and 43 as described above.

Here, as described above, the resin-impregnated semi-hard urethane foam layer 41 is formed by impregnating the semi-hard urethane foam layer 41a over its entirety with the liquid isocyanate that is a kind of a liquid thermosetting resin and curing the liquid isocyanate.

The reason why the target of impregnation with the liquid isocyanate is the semi-hard urethane foam layer 41a instead of the two glass fiber mats 42 and 43 in this way is based on the following grounds.

In recent years, the board-type sunshade has been required to have further improved rigidity. Although the two glass fiber mats 42 and 43 are higher in rigidity than the semi-hard urethane foam layer 41a due to the structure thereof, the two glass fiber mats 42 and 43 are formed of glass fibers. For this reason, the two glass fiber mats 42 and 43 are considerably heavier than the semi-hard urethane foam layer 41a formed of urethane foam.

Therefore, from the viewpoint of the weight reduction of the sunshade 40, it is a matter of course that the increase in the basis weight of each of the two glass fiber mats 42 and 43 is limited. Accordingly, an increase in the basis weight of the liquid isocyanate impregnated into the two glass fiber mats 42 and 43 is also limited.

In addition, since each of the glass fiber mats 42 and 43 is formed of a large number of glass fibers, each of the glass fiber mats 42 and 43 does not have air permeability that the semi-hard urethane foam layer 41a has. Therefore, the liquid isocyanate hardly impregnates into the two glass fiber mats 42 and 43. Therefore, when the liquid isocyanate is impregnated into the two glass fiber mats 42 and 43, the total basis weight of the liquid isocyanate is considerably smaller than the basis weight of the liquid isocyanate impregnated into the semi-hard urethane foam layer 41a described above.

In this case, even if the liquid isocyanate is impregnated into the two glass fiber mats 42 and 43 and is cured, the rigidity of each of the two glass fiber mats 42 and 43 cannot be improved to the extent that the recent improvement requirement for the board-type sunshade described above can be satisfied.

On the other hand, since the semi-hard urethane foam layer 41a has good air permeability due to the foam structure thereof, the liquid isocyanate easily infiltrates or impregnates into the semi-hard urethane foam layer 41a. This means that the basis weight of the liquid isocyanate impregnated into the semi-hard urethane foam layer 41a is much more easily increased as compared with the case of impregnating the liquid isocyanate into the two glass fiber mats 42 and 43.

In other words, since the basis weight of the semi-hard urethane foam layer 41a can be considerably increased as compared with the basis weight of each of the two glass fiber mats 42 and 43, the basis weight of the liquid isocyanate that can be impregnated into the semi-hard urethane foam layer 41a can be further increased as compared with the basis weight of the liquid isocyanate impregnated into each of the two glass fiber mats 42 and 43.

For this reason, the predetermined basis weight range of the basis weight of the isocyanate impregnated into the semi-hard urethane foam layer 41a is set to 100 (g/m²) to 500 (g/m²). In addition, in the first embodiment, the basis weight of the isocyanate impregnated into the semi-hard urethane foam layer 41a has more preferably a value within 200 g/m²±20 g/m² (for example, 200 g/m²).

Focusing on the above, in the first embodiment, the semi-hard urethane foam layer 41a is uniformly impregnated with the liquid isocyanate. Further, since the basis weight of the semi-hard urethane foam layer 41a can be considerably increased as compared with the basis weight of each of the two glass fiber mats 42 and 43, the basis weight of the liquid isocyanate that can be impregnated into the semi-hard urethane foam layer 41a can be further increased as compared with the sum of the basis weight of the liquid isocyanate that can be impregnated into each of the two glass fiber mats 42 and 43.

Since the isocyanate described above is a thermosetting resin, if the liquid isocyanate impregnated throughout the entirety of the semi-hard urethane foam layer 41a as described above is cured, a core member having much higher rigidity than the case where the liquid isocyanate is impregnated and cured in each of the two glass fiber mats 42 and 43 can be formed as the core member 40a of the sunshade 40.

Therefore, the rigidity of the resin-impregnated semi-hard urethane foam layer 41 formed by impregnating the semi-hard urethane foam layer 41a with the liquid isocyanate and curing the liquid isocyanate as described above can be much improved as compared with the sum of the respective rigidities of the two glass fiber mats in which the liquid isocyanate is impregnated and cured. This means that the requirement for improving the rigidity of the sunshade described at the beginning of the present specification can be sufficiently satisfied.

As shown in FIG. 9, the front skin member 40b includes the barrier film 44 and the front skin layer 45. The barrier film 44 has adhesive performance and gas sealing performance. The barrier film 44 has the adhesive performance on both front and back surfaces thereof.

Accordingly, the barrier film 44 plays a role of bonding the front skin layer-side glass fiber mat 42 to the front skin layer 45 based on the adhesion performance thereof. In addition, the barrier film 44 plays a role of sealing leakage of a gas released from the resin-impregnated semi-hard urethane foam layer 41 to the outside when the sunshade 40 is formed by press molding under the gas sealing performance thereof.

The front skin layer 45 is formed in a layer shape with a predetermined front skin material. The front skin layer 45 is bonded to and laminated along the front skin layer-side glass fiber mat 42 with the barrier film 44 so as to face the resin-impregnated semi-hard urethane foam layer 41 through the front skin layer-side glass fiber mat 42. The front skin layer 45 faces the interior of the vehicle compartment on the front surface thereof (a surface located on the vehicle compartment side). Examples of the predetermined skin material described above include polyurethane foam laminate knitted fabric, fabric, and needle punch nonwoven fabric.

As shown in FIG. 9, the back skin member 40c includes the adhesive film 46 and the back skin layer 47. The adhesive film 46 plays a role of bonding the back skin layer-side glass fiber mat 43 to the back skin layer 47 based on the adhesion performance thereof. In addition, the adhesive film 46 exhibits an adhesive function on both front and back surfaces thereof.

The back skin layer 47 is formed in a layer shape with a predetermined back skin material. The back skin layer 47 is bonded to and laminated along the back skin layer-side glass fiber mat 43 with the adhesive film 46 so as to face the resin-impregnated semi-hard urethane foam layer 41 through the back skin layer-side glass fiber mat 43. An example of the predetermined back skin material described above includes polyester nonwoven fabric. In the first embodiment, the total basis weight and the total thickness of the sunshade 40 are, for example, 1430 g/m² and 7.0 mm, respectively.

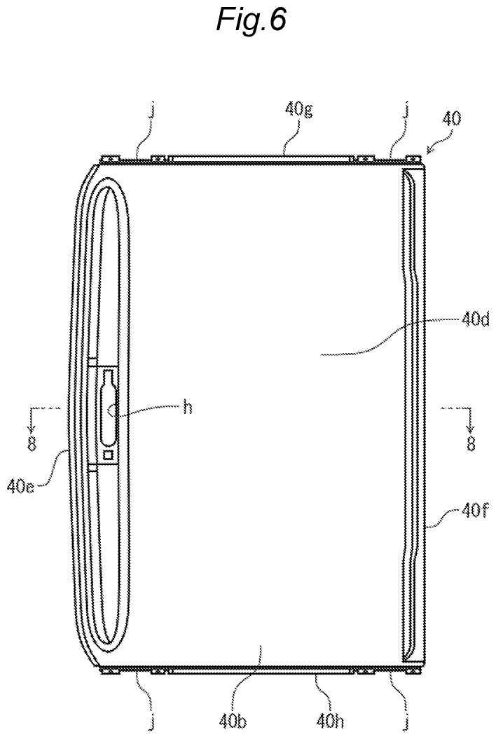

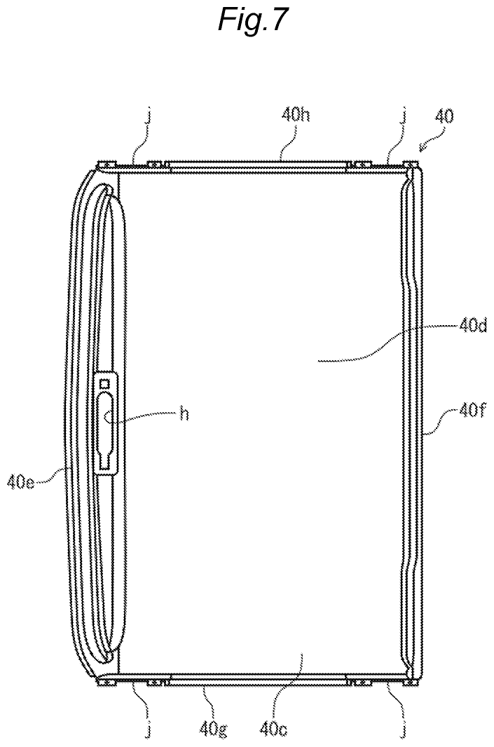

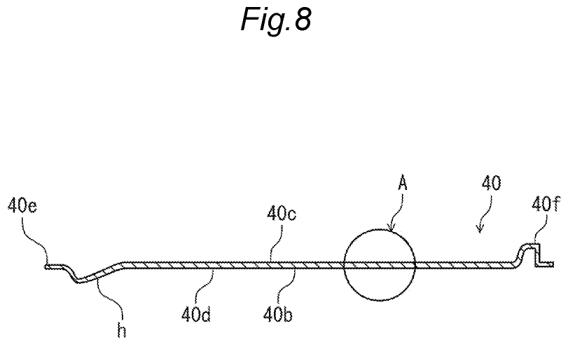

As shown in FIGS. 6 and 7, the sunshade 40 laminated as described above includes a flat plate center 40d, front and rear ends 40e and 40f, and left and right edges 40g and 40h. When the sunshade 40 thus configured is formed by press molding as described above, the sunshade 40 is compressed and molded into a predetermined three-dimensional flat shape having front and back surface shapes as shown in FIGS. 6 and 7 and a longitudinal sectional shape as shown in FIG. 8.

In the first embodiment, FIG. 6 is a view of the sunshade 40 as viewed from the front surface thereof (the surface located on the vehicle compartment side of the vehicle body 10). Meanwhile, FIG. 7 is a view of the sunshade 40 as viewed from the back surface thereof (the surface located on the sunroof side). In addition, the front surface of the front skin layer 45 of the sunshade 40 (the surface located on the vehicle compartment side of the vehicle body 10) is referred to as a front surface of the sunshade 40, and the back surface of the back skin layer 47 of the sunshade 40 (the surface located on the sunroof side) is referred to as a back surface of the sunshade 40.

Here, the front and rear ends 40e and 40f and the left and right edges 40g and 40h are compressed and molded at a compression rate higher than a compression rate for the flat plate center 40d. Therefore, the front and rear ends 40e and 40f and the left and right edges 40g and 40h have high rigidity and are harder than the flat plate center 40d. In the first embodiment, the compression rate for each of the front and rear ends 40e and 40f may be the same as the compression rate for each of the left and right edges 40g and 40h or may be higher or lower than the compression rate for each of the left and right edges 40g and 40h.

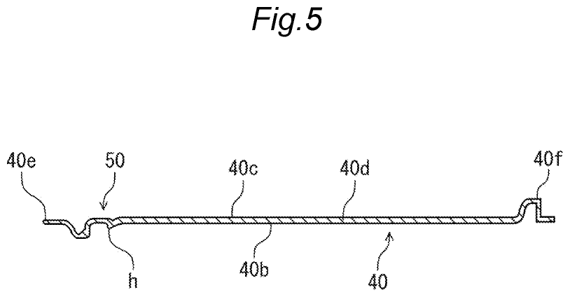

Thus, in the sunshade 40, among the front and rear ends 40e and 40f, the front end 40e extends forward from the front end of the flat plate center 40d as shown in any of FIGS. 5 to 7. Meanwhile, as shown in FIG. 5, the rear end 40f is formed to extend from the rear end of the flat plate center 40d and protrude in a U shape toward the back skin member 40c. In the first embodiment, the rear end 40f is also referred to as a rear locking portion 40f. In addition, when the sunshade apparatus SD reaches the rear sliding end, the rear locking portion 40f is locked to the rear inner edge of the inner plate opening to restrict the sunshade apparatus SD from sliding further rearward.

The left and right edges 40g and 40h correspond to the left and right edges of the sunshade 40. These left and right edges 40g and 40h are formed to extend outward in opposite directions from the left and right edges of the flat plate center 40d as shown in FIGS. 6 and 7.

Here, the left edge 40g has front and rear cutout portions j (see FIG. 6) for attaching each of two sliding members 60 (described later), and these front and rear cutout portions j are cut at front and rear portions of the left edge 40g in a U shape. Meanwhile, the right edge 40h has front and rear cutout portions j (see FIG. 6) for attaching each of remaining two sliding members 60 (described later), and these front and rear cutout portions j are cut at front and rear portions of the right edge 40h in a U shape.

The knob 50 is fitted in a narrow through-hole h (see FIGS. 6 to 8) formed at the front end side left-right center portion of flat plate center 40d (see FIGS. 3 to 5). Here, the knob 50 is formed in a recessed shape so as to be recessed from the side of the front skin layer 45 to the side of the back skin layer 47 and so as to be fittable into the narrow through-hole h of the flat plate center 40d.

Thus, when an occupant causes the sunshade 40 to slide in the front-rear direction along the left and right guide rails 30 with the knob 50 by his hand in the vehicle compartment of the vehicle body 10, the sunshade apparatus SD slides in the front-rear direction along the left and right guide rails 30. When the sunshade apparatus SD is located at the front sliding end, the sunshade apparatus SD closes the window WD by the sunshade 40. When the sunshade apparatus SD is located at the rear sliding end, the sunshade apparatus SD opens the window WD by the sunshade 40. In addition, when the sunshade apparatus SD closes the window WD, the sunshade 40 is in a closed state, whereas when the sunshade apparatus SD opens the window WD, the sunshade 40 is in an open state.

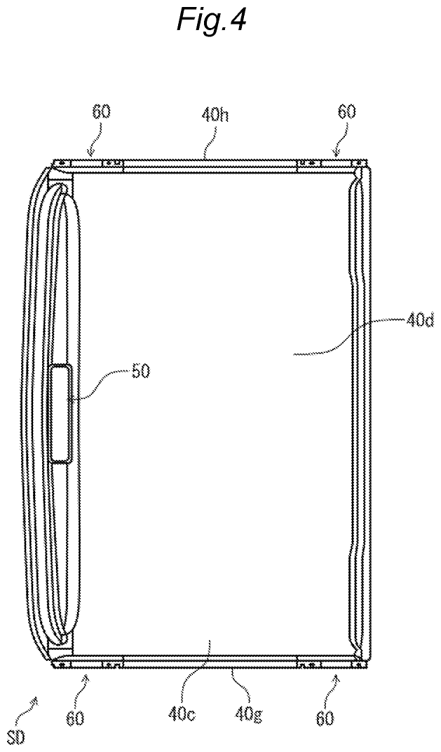

As can be seen from FIGS. 3 and 4, two of each of the four sliding members 60 are assembled at the front and rear portions of the left edge 40g and the front and rear portions of the right edge 40h of the sunshade 40. Hereinafter, in the first embodiment, among the four sliding members 60, the two sliding members 60 attached to the front and rear portions of the left edge 40g of the sunshade 40 are referred to as a left front sliding member 60 and a left rear sliding member 60. Further, the two sliding members 60 attached to the front and rear portions of the right edge 40h of the sunshade 40 are referred to as a right front sliding member 60 and a right rear sliding member 60.

Specifically, the left front sliding member 60 is attached to the front cutout portion j (see FIG. 6) formed in the left edge 40g of the sunshade 40, and the left rear sliding member 60 is attached to the rear cutout portion j (see FIG. 6) formed in the left edge 40g of the sunshade 40. Further, the right front sliding member 60 is attached to the front cutout portion j (see FIG. 6) formed in the right edge 40h of the sunshade 40, and the right rear sliding member 60 is attached to the rear cutout portion j (see FIG. 6) formed in the right edge 40h of the sunshade 40. In addition, the four sliding members 60 have the same configuration.

In the first embodiment configured as described above, the core member 40a of the sunshade 40 is formed of the two glass fiber mats 42 and 43 and the resin-impregnated semi-hard urethane foam layer 41 laminated between the two glass fiber mats 42 and 43 as described above.

In the core member 40a, the resin-impregnated semi-hard urethane foam layer 41 is formed by uniformly impregnating the entirety of the semi-hard urethane foam layer 41a with the liquid isocyanate and curing the liquid isocyanate as described above.

Here, the basis weight of the liquid isocyanate impregnated into the semi-hard urethane foam layer 41a can be much larger than the sum of the basis weight of the liquid isocyanate when the liquid isocyanate is impregnated into each of the two glass fiber mats 42 and 43 due to the structure of the semi-hard urethane foam layer 41a as described above. In other words, the basis weight of isocyanate impregnated in the resin-impregnated semi-hard urethane foam layer 41 can be much increased as compared with the sum of the basis weight of isocyanate that can be impregnated into each of the two glass fiber mats 42 and 43.

According to this configuration, the core member 40a has much higher rigidity than the core member including the two resin-impregnated glass fiber mats and the semi-hard urethane foam layer 41a formed by impregnating the two glass fiber mats 42 and 43 with the liquid isocyanate and curing the liquid isocyanate. Therefore, the board-type sunshade 40 including the core member 40a is capable of keeping the original board shape favorably. As a result, sliding of the sunshade apparatus SD in the front-rear direction along the two guide rails 30 can be more smoothly performed as compared with the conventional sunshade apparatus.

In the first embodiment, as described above, the core member 40a of the sunshade 40 is constructed by the laminate formed of the front skin layer-side glass fiber mat 42, the resin-impregnated semi-hard urethane foam layer 41, and the back skin layer-side glass fiber mat 43.

In the laminate, the resin-impregnated semi-hard urethane foam layer 41 is formed by uniformly impregnating the entirety of the semi-hard urethane foam layer 41a with the liquid isocyanate and curing the liquid isocyanate, with no need for curing due to impregnation of the two glass fiber mats 42 and 43 formed of glass fibers that are difficult to be impregnated with the liquid isocyanate.

In this connection, in testing the bending strength of the sunshade 40 formed as described above, a working sample of the sunshade 40 was prepared, and the bending strength of the working sample was tested by a bending strength testing apparatus.

The working sample is formed with a configuration corresponding to the flat plate center 40d of the sunshade 40. The working sample is formed to have a flat plate shape of, for example, width 50 mm×length 150 mm×total thickness 7.0 mm.

In addition, the basis weight of the liquid isocyanate impregnated into the semi-hard urethane foam layer of the working sample is 200 g/m², and the basis weight of each of the front skin layer-side glass fiber mat and the back skin layer-side glass fiber mat of the working sample is 300 g/m².

In the bending strength test, a sample having the same configuration as that of the flat plate center of the conventional sunshade was prepared as a comparative sample. The conventional sunshade has the front skin member 40b and the back skin member 40c of the sunshade 40, and has a core member different from the core member 40a of the sunshade 40.

The core member of the conventional sunshade includes a front skin layer-side resin-impregnated glass fiber mat, a semi-hard urethane foam layer 41a, and a back skin layer-side resin-impregnated glass fiber mat, which correspond to the front skin layer-side glass fiber mat 42, the resin-impregnated semi-hard urethane foam layer 41, and the back skin layer-side glass fiber mat 43 of the sunshade 40.

Here, the front skin layer-side resin-impregnated glass fiber mat and the back skin layer-side resin-impregnated glass fiber mat are respectively formed by impregnating each entirety of the front skin layer-side glass fiber mat 42 and the back skin layer-side glass fiber mat 43 of the sunshade 40 with the liquid isocyanate and curing the liquid isocyanate. In addition, the basis weight of the liquid isocyanate impregnated into each of the front skin layer-side resin-impregnated glass fiber mat and the back skin layer-side resin-impregnated glass fiber mat has a value within 50 g/m²±5 g/m² (for example, 30 g/m²). The comparative sample is formed to have a flat plate shape of width 50 mm×length 150 mm×total thickness 7.0 mm, which is similar to the working sample described above.

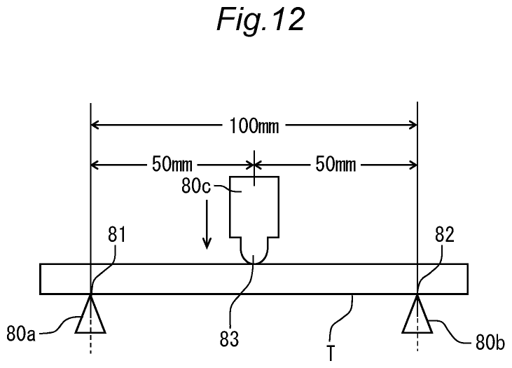

As shown in FIG. 12, the bending strength testing apparatus includes two fulcrum elements 80a and 80b and a load element 80c. As shown in FIG. 12, the two fulcrum elements 80a and 80b are spaced apart from each other in the horizontal direction, and a distance between fulcrums 81 and 82 of the two fulcrum elements 80a and 80b in the horizontal direction is set to 100 mm.

Further, the load element 80c is vertically movably supported in the middle between the two fulcrum elements 80a and 80b, and the load element 80c faces, at a lower end 83 thereof, an intermediate position between the fulcrums 81 and 82 of the two fulcrum elements 80a and 80b. In addition, a distance between each of two fulcrums 81 and 82 and the lower end 83 of the load element 80c in the horizontal direction is 50 mm (see FIG. 12).

When the bending strength test of a set sample T is performed by the bending strength testing apparatus configured as described above, the set sample T is set on the fulcrums 81 and 82 so as to extend over the two fulcrum elements 80a and 80b as shown in FIG. 12.

In such a set state, when the load element 80c is moved downward toward the intermediate position between the two fulcrums 81 and 82, the load element 80c applies, at the lower end 83 thereof, a load downward toward the center of the set sample T in the left-right direction. As a result, the maximum load of the load on the set sample T and the bending elastic gradient generated when the maximum load is applied to the set sample T can be measured as the bending strength characteristics of the set sample T by the bending strength testing apparatus.

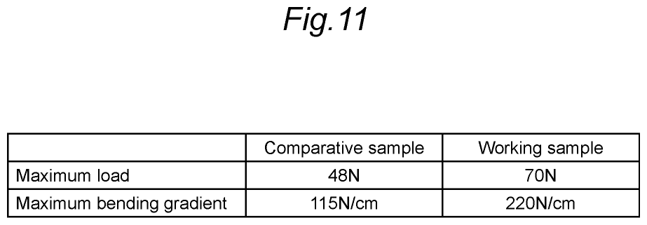

Thus, the comparative sample was set as the set sample T on the fulcrums 81 and 82 of the two fulcrum elements 80a and 80b in the same manner as described above, and a load was applied to the comparative sample by the load element 80c in the same manner as described above. According to the test, the bending strength characteristics of the comparative sample were obtained as a maximum bending strength of 48 N and a bending elastic gradient of 115 N/cm as shown in the table of FIG. 11.

Meanwhile, the working sample described above was set as the set sample T on the fulcrums 81 and 82 of the two fulcrum elements 80a and 80b in the same manner as described above, and a load was applied to the working sample by the load element 80c in the same manner as described above. According to the test, the bending strength characteristics of the working sample were obtained as a maximum bending strength of 70 N and a bending elastic gradient of 220 N/cm as shown in the table of FIG. 11.

It can be seen from a comparison between the bending strength characteristics that the maximum load to the working sample is about 1.5 times the maximum load to the comparative sample. In this case, it can be seen that the bending elastic gradient of the working sample is about twice the bending elastic gradient of the comparative sample.

Therefore, it can be seen that the bending strength characteristics of the working sample are significantly improved as compared with the bending strength characteristics of the comparative sample. In other words, it can be seen that the sunshade 40 manufactured in the first embodiment has much higher rigidity than that of the conventional sunshade.

Further, in the first embodiment, by setting the semi-hard urethane foam layer 41a as a target to be impregnated with the liquid isocyanate, as described above, the basis weight of the liquid isocyanate to be impregnated can be increased to a basis weight capable of further improving the rigidity of the sunshade 40, for example, 200 g/m². As a result, as can be seen from the bending strength test results described above, the rigidity of the core member 40a and thus the sunshade 40 can be significantly improved as compared with the case where the two glass fiber mats 42 and 43 are impregnated with the liquid isocyanate.

### Second Embodiment

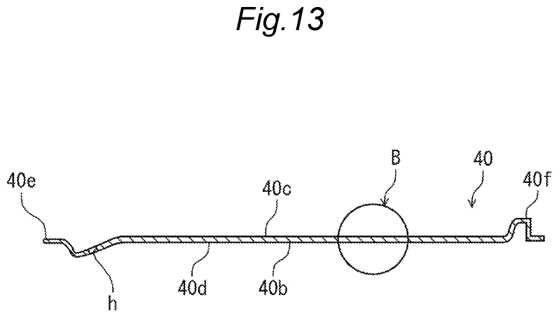

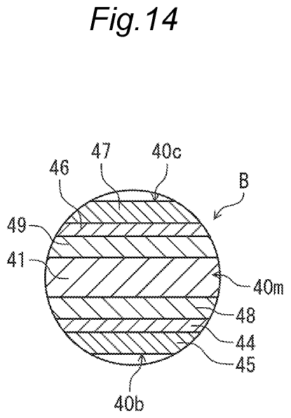

FIG. 13 shows a main portion of a second embodiment of a sunshade apparatus according to the present invention. In the second embodiment, the sunshade apparatus includes a sunshade (hereinafter, referred to as a sunshade 40 also in the second embodiment) shown in FIGS. 13 and 14 in place of the sunshade 40 in the sunshade apparatus SD according to the first embodiment. Note that the sunshade apparatus according to the second embodiment is also denoted by a reference sign SD, which is similar to the sunshade apparatus SD according to the first embodiment.

The sunshade 40 according to the second embodiment includes the front skin member 40b and the back skin member 40c according to the first embodiment, and also includes a core member 40m in place of the core member 40a (see FIGS. 13 and 14). The core member 40m is laminated between the front skin member 40b and the back skin member 40c.

The core member 40m includes the resin-impregnated semi-hard urethane foam layer 41 described in the first embodiment, and also includes a front skin layer-side resin-impregnated glass fiber mat 48 and a back skin layer-side resin-impregnated glass fiber mat 49, in place of the front skin layer-side glass fiber mat 42 and the back skin layer-side glass fiber mat 43 described in the first embodiment. In the second embodiment, the resin-impregnated semi-hard urethane foam layer 41 is laminated between the front skin layer-side resin-impregnated glass fiber mat 48 and the back skin layer-side resin-impregnated glass fiber mat 49 (see FIG. 14).

The front skin layer-side resin-impregnated glass fiber mat 48 is formed by uniformly impregnating the entirety of the front skin layer-side glass fiber mat 42 described in the first embodiment with the liquid isocyanate and curing the liquid isocyanate. Meanwhile, the back skin layer-side resin-impregnated glass fiber mat 49 is formed by uniformly impregnating the entirety of the back skin layer-side glass fiber mat 43 described in the first embodiment with the liquid isocyanate and curing the liquid isocyanate.

In the second embodiment, the basis weight of the liquid isocyanate impregnated into the front skin layer-side glass fiber mat 42 in order to form the front skin layer-side resin-impregnated glass fiber mat 48 is set to a value within a predetermined basis weight range, for example, 30 g/m². Meanwhile, the basis weight of the liquid isocyanate impregnated into the back skin layer-side glass fiber mat 43 in order to form the back skin layer-side resin-impregnated glass fiber mat 49 is also set to a value within a predetermined basis weight range, for example, 30 g/m². Accordingly, the total basis weight and the total thickness of the sunshade 40 in the second embodiment are, for example, 1290 g/m² and 7.0 mm, respectively.

In the second embodiment, the predetermined basis weight range which is the range of the basis weight of the liquid isocyanate impregnated into the front skin layer-side glass fiber mat 42 and the back skin layer-side glass fiber mat 43 in order to form the front skin layer-side resin-impregnated glass fiber mat 48 and the back skin layer-side resin-impregnated glass fiber mat 49 is set to 20 g/m² to 50 g/m².

The lower limit value is set to 20 g/m² in the predetermined basis weight range since the rigidity as a resin-impregnated glass fiber mat is insufficient when the basis weight is less than 20 g/m². Meanwhile, the upper limit value is set to 50 g/m² since the glass fiber mat is less likely to be impregnated due to its configuration when the basis weight exceeds 50 g/m². In addition, the basis weight of the liquid isocyanate impregnated into each of the front skin layer-side glass fiber mat 42 and the back skin layer-side glass fiber mat 43 may be a value within 30 g/m²±3 g/m², for example, 30 g/m².

Thus, in the sunshade 40 according to the second embodiment, the core member 40m configured as described above is laminated between the front skin member 40b and the back skin member 40c as shown in FIG. 14. Under such lamination, the sunshade 40 is subjected to compression molding so as to have a cross-sectional shape as shown in FIG. 13. Other configurations of the sunshade apparatus according to the second embodiment are similar to those of the first embodiment.

In the sunshade 40 according to the second embodiment configured as described above, the core member 40m, which is different from the core member 40a described in the first embodiment, adopts the two resin-impregnated glass fiber mats 48 and 49, instead of the two glass fiber mats 42 and 43 of the core member 40a. Moreover, the core member 40m is formed by laminating the resin-impregnated semi-hard urethane foam layer 41 described in the first embodiment between the two resin-impregnated glass fiber mats 48 and 49.

Therefore, the core member 40m in the second embodiment has total rigidity obtained by adding the rigidity of each of the two resin-impregnated glass fiber mats 48 and 49 in addition to the rigidity of the resin-impregnated semi-hard urethane foam layer 41 described in the first embodiment.

As a result, the rigidity of the sunshade 40 in the second embodiment can be further improved as compared with the rigidity of the sunshade 40 in the first embodiment, based on the total rigidity of the core member 40m. This means that the original board shape (see FIG. 13) of the sunshade 40 of the second embodiment can be kept more favorably than that of the sunshade 40 of the first embodiment. Other operations and effects in the second embodiment are similar to those in the first embodiment.

### Third Embodiment

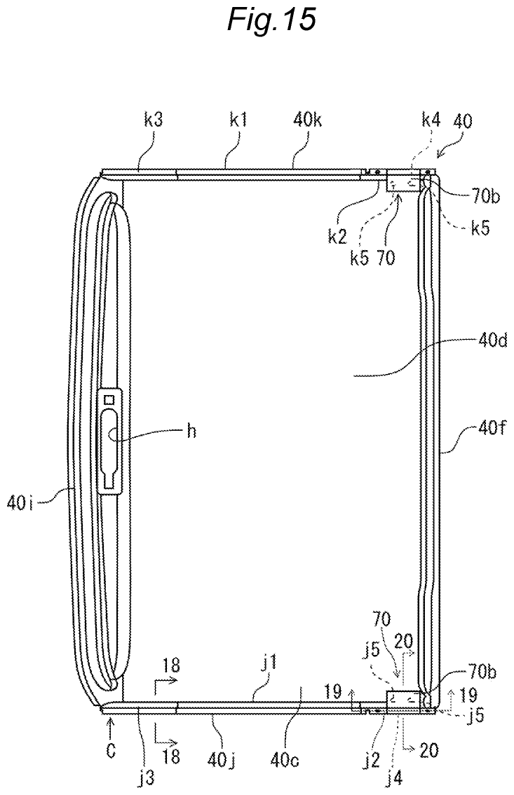

FIG. 15 shows a third embodiment of a sunshade apparatus for motor vehicles according to the present invention. The sunshade apparatus in the third embodiment has a configuration in which the board-type sunshade 40 of the sunshade apparatus SD described in the first embodiment includes a front end 40i, a left edge 40j, and a right edge 40k in place of the front end 40e, the left edge 40g, and the right edge 40h. Note that the sunshade apparatus according to the third embodiment is also denoted by a reference sign SD, which is similar to the sunshade apparatus SD according to the first embodiment.

Further, the sunshade apparatus SD according to the third embodiment has a configuration including a left rear sliding member 70 and a right rear sliding member 70 in place of the left rear sliding member 60 and the right rear sliding member 60 in the sunshade apparatus SD described in the first embodiment. In addition, in the third embodiment, the left front sliding member 60 and the right front sliding member 60 described in the first embodiment are not adopted.

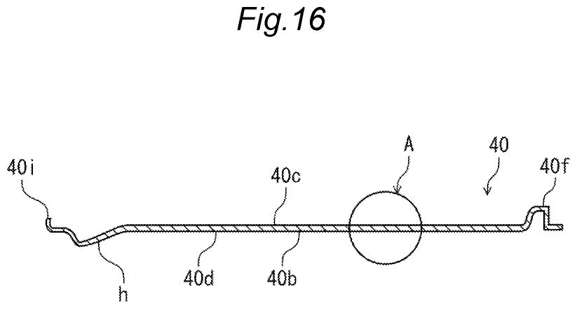

First, the configuration of the front end 40i of the board-type sunshade 40 according to the third embodiment is described. As shown in any of FIGS. 15 to 17, in subjecting the front end 40i to compression molding at a compression rate higher than the compression rate for the flat plate center 40d as described in the first embodiment, the front end 40i is subjected to heat-compression molding in addition to the compression molding so as to be curved toward the back skin member 40c while being protruded forward in a gently convex curved shape from the front end of the flat plate center 40d.

Next, the configuration of each of the left and right edges 40j and 40k of the board-type sunshade 40 according to the third embodiment is described. Among the left and right edges 40j and 40k, the left edge 40j is formed to extend leftward from the left side of the flat plate center 40d (see FIG. 15), similarly to the left edge 40g described in the first embodiment. Note that FIG. 15 is a view of the sunshade 40 as viewed from the back surface (the surface located on the roof side of the motor vehicle) side.

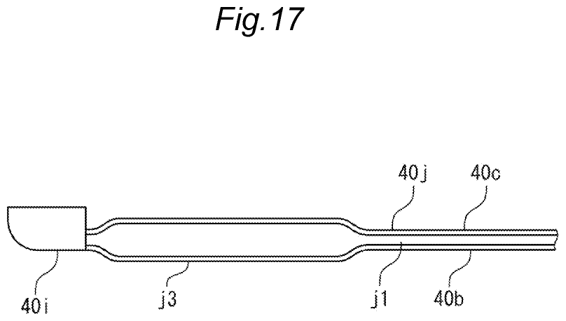

The left edge 40j is subjected to compression molding in a longitudinal middle portion j1 and a longitudinal rear portion j2 at a compression rate similar to the compression rate for the left edge 40g described in the first embodiment (see FIG. 17). Further, a longitudinal front portion j3 of the left edge 40j is subjected to compression molding as a left support portion (hereinafter, also referred to as a left support portion j3) at a compression rate lower than the compression rates for the longitudinal middle portion j1 and the longitudinal rear portion j2, for example, at a compression rate similar to the compression rate for the flat plate center 40d (see FIGS. 15 and 17).

This means that the shape of the left support portion j3 has a shape (bulging shape) bulging more than the shapes of the longitudinal middle portion j1 and the longitudinal rear portion j2. The left support portion j3 serves as a substitute for the left front sliding member 60 described in the first embodiment.

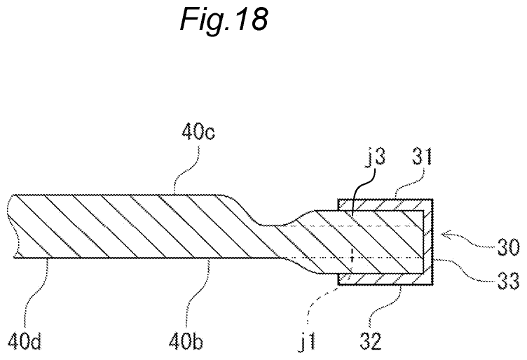

Here, as shown in FIG. 18, the left support portion j3 is formed so as to be displaced downward in the drawing (toward the front skin member 40b) from the flat plate center 40d. Accordingly, the left support portion j3 is located on the lower side of the longitudinal middle portion j1 of the left edge 40j in FIG. 18 at its portion located on the side of the front skin member 40b, while the left support portion j3 is located on the upper side of the longitudinal middle portion j1 of the left edge 40j in FIG. 18 at its portion located on the side of the back skin member 40c. Note that a cutout portion j4 (see FIGS. 15 and 17) similar to the cutout portion j described in the first embodiment is formed by cutting the longitudinal rear portion j2.

Meanwhile, the right edge 40k is subjected to compression molding in a longitudinal middle portion k1 and a longitudinal rear portion k2 at a compression rate similar to the compression rate for the right edge 40h described in the first embodiment. Further, a longitudinal front portion k3 of the right edge 40k is subjected to compression molding as a right support portion (hereinafter, also referred to as a right support portion k3) at a compression rate similar to the compression rates for the longitudinal middle portion k1 and the longitudinal rear portion k2, for example, the compression rate for the flat plate center 40d. This means that the right support portion k3 has a shape (bulging shape) bulging more than the shapes of the longitudinal middle portion k1 and the longitudinal rear portion k2. The right support portion k3 serves as a substitute for the right front sliding member 60 described in the first embodiment.

Here, the right support portion k3 is also formed so as to be displaced downward from the flat plate center 40d, similarly to the left support portion j3. Accordingly, a portion of the right support portion k3 on the front skin member 40b side, which is similar to the portion of the left support portion j3 on the side of the front skin member 40b, is located on the lower side of the longitudinal middle portion k1 of the right edge 40k. Meanwhile, a portion of the right support portion k3 on the side of the back skin member 40c, which is similar to the portion of the left support portion j3 on the back skin member 40c side, is located on the upper side of the longitudinal middle portion k1 of the right edge 40k. Note that a cutout portion k4 (see FIG. 15) similar to the cutout portion j described in the first embodiment is formed by cutting the longitudinal rear portion k2.

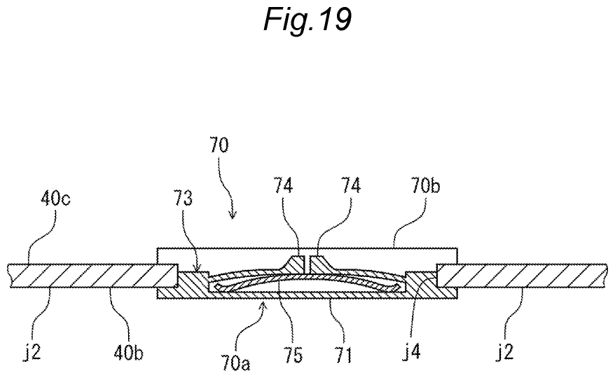

Next, respective configurations of the left rear sliding member 70 and the right rear sliding member 70 in the third embodiment are described. With regard to the left rear sliding member 70 and the right rear sliding member 70, the left rear sliding member 70 is attached to the cutout portion j4 (see FIG. 19) formed in the rear portion j2 of the left edge 40j of the sunshade 40, and the right rear sliding member 70 is attached to the cutout portion k4 (see FIG. 15) formed in the rear portion k2 of the right edge 40k of the sunshade 40.

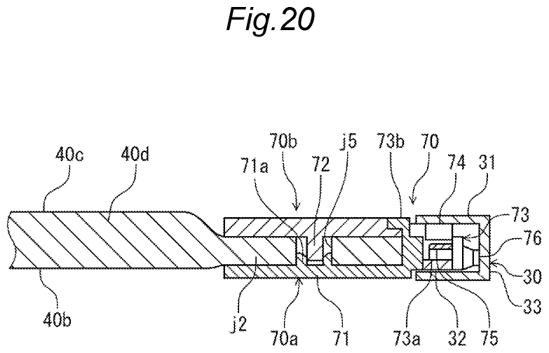

Since both the left rear sliding member 70 and the right rear sliding member 70 have the same configuration, the configuration of the left rear sliding member 70 is described below as an example. As shown in FIGS. 19 and 20, the left rear sliding member 70 includes a member body 70a and an attachment plate 70b. The member body 70a has a bottom plate 71, and the bottom plate 71 clamps the longitudinal rear portion j2 of the left edge 40j with the attachment plate 70b (see FIG. 20).

The clamping is performed as follows. Specifically, the bottom plate 71 is fitted in a pair of through-holes j5 (FIG. 20 shows only one through-hole j5) of the longitudinal rear portion j2 at a pair of bifurcated portions 71a (FIG. 20 shows only one bifurcated portion 71a) (see FIG. 15). The pair of bifurcated portions 71a is formed to protrude from the bottom plate 71 toward the attachment plate 70b correspondingly to the pair of through-holes j5 of the longitudinal rear portion j2.

On the other hand, the attachment plate 70b is engaged with the inside of the pair of bifurcated portions 71a of the bottom plate 71 inside the pair of through-holes j5 of the longitudinal rear portion j2 by a pair of protrusions 72 (FIG. 20 shows only one protrusion 72). Thus, the above clamping is performed. Note that the pair of protrusions 72 is formed to protrude from the attachment plate 70b toward the bottom plate 71 so as to face the pair of through-holes j5 of the longitudinal rear portion j2.

As shown in any of FIGS. 19 and 20, the member body 70a includes a longitudinal case 73, a pair of sliding contact pieces 74, a spring piece 75, and a pair of elastic pieces 76. As shown in FIG. 20, a bottom wall 73a of the longitudinal case 73 is formed integrally with the bottom plate 71, and an L-shaped wall 73b of the longitudinal case 73 is engaged with the left end of the attachment plate 70b as shown in FIG. 20, so that the above-described clamping with the attachment plate 70b by the bottom plate 71 is maintained.

As shown in FIG. 19, the pair of sliding contact pieces 74 is accommodated in the case 73 with the spring piece 75 located therebelow, so that the spring piece 75 biases the pair of sliding contact pieces 74 toward an upper wall (hereinafter, referred to as an upper wall 31) of the guide rail 30. The pair of sliding contact pieces 74 is thus brought into sliding contact with the inner surface of the upper wall 31 of the guide rail 30.

Here, the spring piece 75 is interposed between a lower wall (hereinafter, referred to as a lower wall 32) of the guide rail 30 and the pair of sliding contact pieces 74 to bias the pair of sliding contact pieces 74 toward the upper wall 31 of the guide rail 30. The pair of elastic pieces 76 is protruded on the outer surface of a bottom wall 33 (see FIG. 20) of the guide rail 30, at an interval in the longitudinal direction of the case 73. The pair of elastic pieces 76 thus elastically abut on the inner surface of the bottom wall 33 of the guide rail 30. Note that the right rear sliding member 70 is also formed of constituent components similar to those of the left rear sliding member 70.

As described above, the left and right support portions j3 and k3 (see FIG. 15) and the left and right rear sliding members 70 (see FIG. 15) are provided in the sunshade 40. Here, in the left edge 40j of the sunshade 40, the left support portion j3, which is the longitudinal front portion j3, is subjected to compression molding at a compression rate lower than the compression rates for the longitudinal middle portion j1 and the longitudinal rear portion j2 of the left edge 40j of the sunshade 40, and has a shape (bulging shape) bulging more than the shapes of the longitudinal middle portion j1 and the longitudinal rear portion j2.

Further, in the right edge 40k of the sunshade 40, the right support portion k3, which is the longitudinal front portion k3, is subjected to compression molding at a compression rate lower than the compression rates for the longitudinal center portion k1 and the longitudinal rear portion k2 of the right edge 40k of the sunshade 40, and has a shape (bulging shape) bulging more than the shapes of the longitudinal center portion k1 and the longitudinal rear portion k2.

In addition, the left rear sliding member 70 is in sliding contact with the lower wall 32 and the upper wall 31 of the left guide rail 30 under the biasing force of the spring piece 75, at the bottom wall 73a of the case 73 and the pair of sliding contact pieces 74.

According to the above configuration, the left edge 40j of the sunshade 40 is capable of causing the longitudinal center portion j1 and the longitudinal rear portion j2 to float from the respective inner surfaces of the upper wall 31 and the lower wall 32 of the left guide rail 30, and the right edge 40k of the sunshade 40 is capable of causing the longitudinal center portion k1 and the longitudinal rear portion k2 to float from the respective inner surfaces of the upper wall 31 and the lower wall 32 of the right guide rail 30.

As a result, the left and right edges 40j and 40k of the sunshade 40 respectively come into sliding contact with the left and right guide rails 30 together with the left and right rear sliding members 70 only by the left and right support portions j3 and k3. Therefore, in opening and closing the sunshade apparatus SD, the sunshade apparatus SD can be always opened and closed with sliding resistance that enables smooth opening and closing operations. Other configurations of the sunshade apparatus SD according to the third embodiment are similar to those according to the first embodiment.

As described above, in the third embodiment, in the case where the front end 40i of the board-type sunshade 40 is subjected to heat-compression molding at the compression rate higher than the compression rate for the flat plate center 40d as described in the first embodiment, the front end 40i is subjected to heat-compression molding in addition to the compression molding so as to be curved toward the back skin member 40c while being extended in a curved shape that is gently protruded forward from the front end of the flat plate center 40d. At this time, the front end 40i is fused by the heat compression from the front skin member 40b side to the back skin member 40c side at the time of heat-compression molding.

Therefore, at the front end 40i of the sunshade 40, the core member 40a is not exposed from the front end 40i to the front skin member 40b. As a result, even when the sunshade 40 is visually recognized from the front skin layer 45 side, the end surface of the core member 40a is not visually recognized, and the aesthetic appearance viewed from the front end 40i of the sunshade 40 can be favorably ensured.

In addition, the front end 40i of the sunshade 40 is formed by heat-compression molding so as to be curved toward the back skin member 40c while being extended in a curved shape that is gently protruded forward from the front end of the flat plate center 40d. In addition, in the core member 40a, the resin-impregnated semi-hard urethane foam layer 41 laminated between the two glass fiber mats 42 and 43 is formed by impregnating the entire semi-hard urethane foam layer 41a with the liquid isocyanate and curing the liquid isocyanate at the time of the heat-compression molding, as described in the first embodiment.

Here, the basis weight of the liquid isocyanate impregnated into the semi-hard urethane foam layer 41a is much larger than the sum of the basis weight of the liquid isocyanate in the case where the two glass fiber mats 42 and 43 are impregnated with the liquid isocyanate, due to the configuration of the semi-hard urethane foam layer 41a as described in the first embodiment. Therefore, the rigidity of the front end 40i of the sunshade 40 is further improved.

Therefore, even if an operator presses the front end 40i by hand in opening and closing the sunshade 40, the front end 40i is capable of firmly keeping its original shape without being deformed at all. Other operations and effects are similar to those of the first embodiment.

In carrying out the present invention, the present invention is not limited to the above embodiments, and the following various modifications can be made.

(1) In carrying out the present invention, a modification may be made by applying the third embodiment to the sunshade apparatus SD described in the second embodiment, in place of the sunshade apparatus SD described in the first embodiment.

In this case, the core member 40m includes the two resin-impregnated glass fiber mats 48 and 49 in addition to the resin-impregnated semi-hard urethane foam layer 41. Therefore, the rigidity of the core member 40m can be further improved as compared with the case of the third embodiment.

Accordingly, the rigidity of the front end 40i of the sunshade 40 can be further improved as well. As a result, the operations and effects of the third embodiment can be further improved by further improving the rigidity.

(2) In carrying out the present invention, the resin impregnated into the resin-impregnated semi-hard urethane foam layer described in the first or second embodiment is not limited to a liquid isocyanate, and may be any thermosetting resin such as a urethane resin.

(3) In carrying out the present invention, the resin impregnated into the resin-impregnated glass fiber mat described in the second embodiment is not limited to a liquid isocyanate, and may be any thermosetting resin such as a urethane resin.

(4) In carrying out the present invention, in the front skin member 40b described in the first embodiment, an adhesive layer such as a simple adhesive film may be laminated on the front skin layer 45 in place of the barrier film 44. Also in the back skin member 40c described in the first embodiment, an adhesive layer may be laminated on the back skin layer 47 in place of the adhesive film 46.

What is claimed is:

1. A board-type sunshade comprising:
a front skin member;
a back skin member; and
a core member laminated between said front skin member and said back skin member,
wherein said core member includes two glass fiber mats and a resin-impregnated semi-hard urethane foam layer laminated between said two glass fiber mats, and
said resin-impregnated semi-hard urethane foam layer is formed by impregnating a semi-hard urethane foam layer over its entirety with a liquid thermosetting resin and curing said liquid thermosetting resin.

2. The board-type sunshade according to claim 1,
wherein said front skin member includes a front skin layer and a front skin layer-side adhesive layer, and
said back skin member includes a back skin layer and a back skin layer-side adhesive layer, and
wherein in said core member, one glass fiber mat of said two glass fiber mats is bonded to said front skin layer with said front skin layer-side adhesive layer so as to face said front skin layer through said front skin layer-side adhesive layer, and the other glass fiber mat is bonded to said back skin layer with said back skin layer-side adhesive layer so as to face said back skin layer through said back skin layer-side adhesive layer.

3. The board-type sunshade according to claim 1, wherein said liquid thermosetting resin impregnated into said semi-hard urethane foam layer has a basis weight within a predetermined basis weight range.

4. The board-type sunshade according to claim 3, wherein said predetermined basis weight range of said basis weight of said liquid thermosetting resin impregnated into said semi-hard urethane foam layer is 150 g/m² to 500 g/m².

5. The board-type sunshade according to claim 4, wherein the basis weight of said liquid thermosetting resin is more preferably 200 g/m²±20 g/m².

6. The board-type sunshade according to claim 1,
wherein said core member includes two resin-impregnated glass fiber mats,
said two resin-impregnated glass fiber mats are formed respectively by impregnating a corresponding one of said two glass fiber mats over its entirety with a liquid thermosetting resin and curing said liquid thermosetting resin, and
said resin-impregnated semi-hard urethane foam layer is laminated between said two resin-impregnated glass fiber mats.

7. The board-type sunshade according to claim 6,
wherein said front skin member includes a front skin layer and a front skin layer-side adhesive layer, and
said back skin member includes a back skin layer and a back skin layer-side adhesive layer, and
wherein in said core member, one resin-impregnated glass fiber mat of said two resin-impregnated glass fiber mats is bonded to said front skin layer with said front skin layer-side adhesive layer so as to face said front skin layer through said front skin layer-side adhesive layer, and the other resin-impregnated glass fiber mat is bonded to said back skin layer with said back skin layer-side adhesive layer so as to face said back skin layer through said back skin layer-side adhesive layer.

8. The board-type sunshade according to claim 6,
wherein in said two resin-impregnated glass fiber mats, each of said glass fiber mats has a basis weight within a first predetermined basis weight range, and
said liquid thermosetting resin impregnated into each of said glass fiber mats has a basis weight within a second predetermined basis weight range, and
wherein in said resin-impregnated semi-hard urethane foam layer, said liquid thermosetting resin impregnated into said semi-hard urethane foam layer has a basis weight within a third predetermined basis weight range.

9. The board-type sunshade according to claim 8,
wherein the first predetermined basis weight range of the basis weight of each of said two glass fiber mats is 100 g/m² to 500 g/m²,
the second predetermined basis weight range of said basis weight of said liquid thermosetting resin impregnated into each of said glass fiber mats is 20 g/m² to 50 g/m², and
the third predetermined basis weight range of the basis weight of said liquid thermosetting resin impregnated into said semi-hard urethane foam layer is 150 g/m² to 500 g/m².

10. The board-type sunshade according to claim 9,
wherein the basis weight of said liquid thermosetting resin impregnated into each of said glass fiber mats is more preferably 30 g/m²±3 g/m², and
the basis weight of said liquid thermosetting resin impregnated into said semi-hard urethane foam layer is more preferably 200 g/m²±20 g/m².

11. The board-type sunshade according to claim 10, wherein said liquid thermosetting resin is a liquid isocyanate.

12. A sunshade apparatus for a motor vehicle to be applied through two guide rails to a window formed in a sunroof of the motor vehicle, for opening and closing the window, which comprises:
a board-type sunshade; and
a plurality of sliding members,
wherein said board-type sunshade includes a front skin member, a back skin member, and a core member laminated between said front skin member and said back skin member,
said core member includes two glass fiber mats and a resin-impregnated semi-hard urethane foam layer laminated between said two glass fiber mats,
said resin-impregnated semi-hard urethane foam layer is formed by impregnating a semi-hard urethane foam layer over its entirety with a liquid thermosetting resin and curing said liquid thermosetting resin, and
said plurality of sliding members are respectively attached to at least rear portions of left and right edges of said board-type sunshade.

13. The sunshade apparatus for the motor vehicle according to claim 12,
wherein said core member includes two resin-impregnated glass fiber mats,
said two resin-impregnated glass fiber mats are formed respectively by impregnating a corresponding one of said two glass fiber mats over its entirety with a liquid thermosetting resin and curing said liquid thermosetting resin,
said resin-impregnated semi-hard urethane foam layer is laminated between said two resin-impregnated glass fiber mats, and
said plurality of sliding members are respectively attached to at least rear portions of left and right edges of said sunshade.

14. The sunshade apparatus for the motor vehicle according to claim 12,
wherein said board-type sunshade includes:
a flat plate center;
front and rear ends respectively extending forward and rearward from said flat plate center; and
left and right edges respectively extending leftward and rightward from said flat plate center,
the left and right edges each include a front portion and a remaining portion excluding the front portion,
the remaining portions each is subjected to compression molding at a compression rate higher than a compression rate for said flat plate center, and the front portions each is subjected to compression molding at a compression rate lower than the compression rate for the remaining portion,
the rear end is subjected to compression molding at a compression rate higher than the compression rate for said flat plate center, and
the front end is compressed at a compression rate higher than the compression rate for said flat plate center and is formed to be curved toward said back skin member in a curved shape that is gently convex forward.

15. The sunshade apparatus for the motor vehicle according to claim 13, wherein said board-type sunshade includes:
a flat plate center;
front and rear ends respectively extending forward and rearward from the flat plate center; and
left and right edges respectively extending leftward and rightward from the flat plate center,
the left and right edges each include a front portion and a remaining portion excluding the front portion,
the remaining portions each is subjected to compression molding at a compression rate higher than a compression rate for the flat plate center, and the front portion is subjected to compression molding at a compression rate lower than the compression rate for the remaining portion,
the rear end is subjected to compression molding at a compression rate higher than the compression rate for the flat plate center, and
the front end is compressed at a compression rate higher than the compression rate for the flat plate center and is formed to be curved toward said back skin member in a curved shape that is gently convex forward.
